(19) United States
(12) Patent Application Publication
(10) Pub. No.: US 2014/0026045 A1
(43) Pub. Date: Jan. 23, 2014

(54) SYSTEM AND METHOD FOR AUTHORING GUIDED PROCEDURES

(71) Applicants: Markus Andres, Malschenberg (DE); Aymen Mouelhi, Juan Les Pins (FR); Constantin Savu, Antibes (FR); Emmanuel Turci, Antibes (FR); Helmut Fieres, Malsch (DE); Roman Rapp, Villeneuve Loubet (FR)

(72) Inventors: Markus Andres, Malschenberg (DE); Aymen Mouelhi, Juan Les Pins (FR); Constantin Savu, Antibes (FR); Emmanuel Turci, Antibes (FR); Helmut Fieres, Malsch (DE); Roman Rapp, Villeneuve Loubet (FR)

(73) Assignee: SAP AG, Walldorf (DE)

(21) Appl. No.: 13/553,551

(22) Filed: Jul. 19, 2012

(51) Int. Cl. G06F 3/01

(52) U.S. Cl. 715/705

(57) ABSTRACT

A software system maintains a plurality of procedures in an infrastructure. The procedures include step by step instructions relating to assisting a user of the infrastructure. The system also provides a software tool via a user interface relating to the plurality of procedures. The software tool is configured to permit a user to create a procedure, to activate the procedure, and to publish the availability of the procedure.

### TECHNICAL FIELD

The present disclosure relates to a system and method for authoring guided procedures, and in an embodiment, but not by way of limitation, a system and method for providing a user interface for authoring guided procedures.

### BACKGROUND

Software systems normally include documentation such as a user's guide, a system guide, and/or an operator's guide. This documentation can be electronic and/or paper based. The documentation normally outlines the general structure of the system, the usage of the system, and the handling of problems in the system. The documentation normally includes a topical index to assist a user in locating topics of interest to the user.

### BRIEF DESCRIPTION OF THE DRAWINGS

FIG. 1 is an example user interface for use in connection with creating or authoring a guided procedure.

FIGS. 2A and 2B are another example user interface for use in connection with creating or authoring a guided procedure.

FIG. 3 is a block diagram of a high level architecture of a guided procedure authoring tool, a guided procedure framework, and a software infrastructure.

FIG. 4 is an example user interface for use in connection with executing a guided procedure.

FIG. 5 is another block diagram of a high level architecture of a guided procedure authoring tool, a guided procedure framework, and a software infrastructure.

FIG. 6 is a flow chart of an example embodiment of a process to execute an authoring of guided procedures.

FIG. 7 is a block diagram illustrating features of a software tool for creating or authoring a guided procedure.

FIG. 8 is a block diagram of an example embodiment of a computer system upon which one or more of the embodiments disclosed herein can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, a software system is part of an infrastructure. The infrastructure includes many business processes, and the infrastructure can also include guided procedures that assist a user of the system in many different aspects of the use, maintenance, and trouble shooting of the system. The guided procedures assist the user by providing step by step instructions that the user can follow to address many different issues in the system. Such guided procedures can be created or authored by a software developer, the provider of the software, a customer of the software provider, or a user of the system. A software tool provided via a user interface (such as a web page) permits such developers, software providers, customers, and users to create (author) a guided procedure, to activate a guided procedure, and to publish the availability of a guided procedure.

When the software tool publishes the availability of a guided procedure, the software tool orchestrates the places in the software infrastructure wherein the guided procedures are placed, and thereby orchestrates which entity or entities can have access to such guided procedures. However, the rapid growth in the size of software systems can make the process of placing these guided procedures increasingly difficult. Consequently, in an embodiment, a more automatic process of placing these guided procedures in the proper places in the infrastructure is available. Also, in such a more automated process, exceptions that occur during the placement of guided procedures, the production life time of the guided procedures, and the domains in the infrastructure in which the guided procedures are placed (e.g., database domain, system domain, and connections domain) are automatically documented.

The issues involved in directing guided procedures to the proper places in the software infrastructure become even more pronounced when the software system is a complex system provided by a rather large software company, and further wherein a customer is given the ability to add guided procedures to the infrastructure on the customer side. In such situations, the software tool is provided to the customer so that the customer can maintain and/or create (author) such guided procedures. The software tool can be used in connection with any guided procedure delivered to the customer by the software company, and any guided procedure the customer itself creates. The software tool can handle and manage all issues that can arise from the placement of the guided procedures such as managing exceptions that occur during the placement of the guided procedures, comparing the different databases in the system that are affected by the placement of the guided procedures (cross-database comparison), and administering technical issues that occur in connection with the placement of the guided procedures.

In an embodiment, the software tool is implemented via a browser, and it permits the authoring of the guided procedures and the placement of the guided procedures in the software infrastructure. The browser-based software tool can also be used to search for guided procedures in the infrastructure, execute the steps of a guided procedure, display which guided procedures are in what portions of the infrastructure, and remove guided procedures from the infrastructure. The software tool also includes a maintenance ability that permits the creation of custom guided procedures in different contexts with different add-ons,

An advantage of such a software tool embodiment is that it permits a software customer to build its own guided procedure(s) that offer a guided solution for assisting others in using, maintaining, and trouble shooting the system. Moreover, such a guided procedure for a guided solution for fixing problems can be either automatic, manual, or customized in nature. In another embodiment, the software providing business organization that developed the system can pre-deliver a guided procedure template (before the delivery of the guided software). Then, the template can be used later on in different portions of the software system such as in business processes, technical operations, and data volume management. The tool can also include a versioning concept, and a manner is which to import or export any guided procedure with or without a delivery of a support package. Versioning, as the name implies, keeps track of the different versions of a guided procedure such as who is permitted to access which version of the guided procedure.

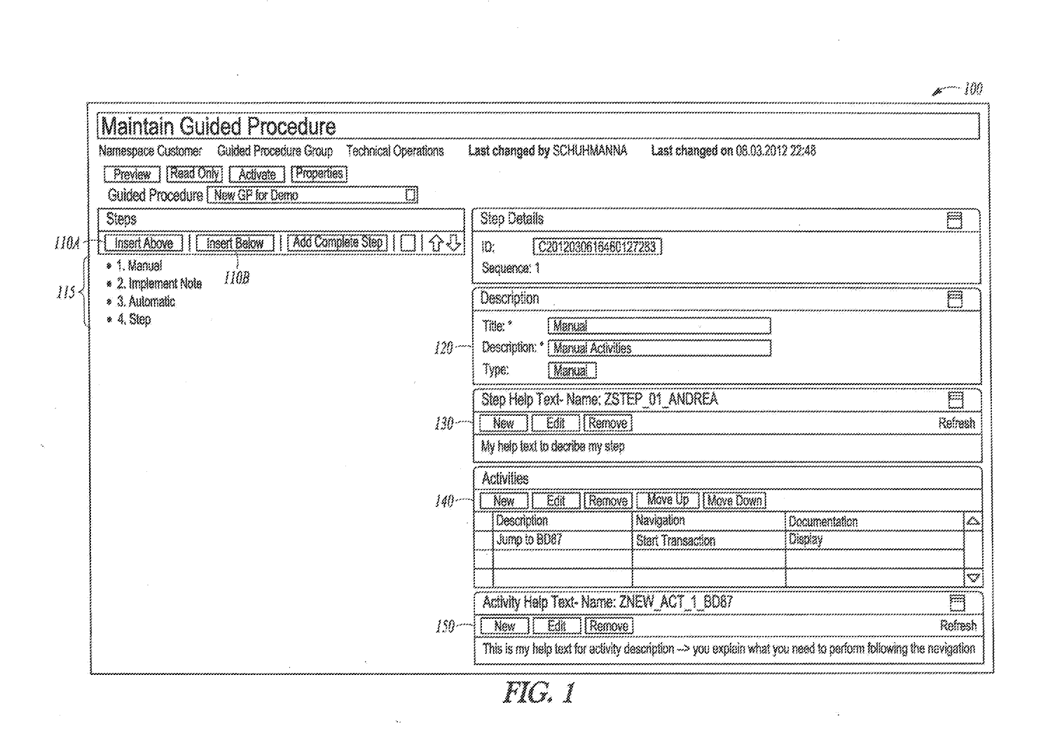

FIG. 1 is an example user interface 100 of a maintenance view of a guided procedure authoring. The user interface 100 is used at design time, and allows a software developer, system analyst, user, or customer to create or author a guided procedure. The user interface 100 basically serves to create a container to hold all the steps of a guided procedure. At 110A and 1108, one can add steps to the guided procedure. Each step includes at least one activity that is used to carry out the step. At 115, the person authoring the guided procedure can indicate that a step in the guided procedure is manual, automatic, or customized. A manual step requires some type of manual action on the part of the person using the guided procedure, such as replacing a damaged disk on the system. An automatic step requires no action by the user of the guided procedure. An example of an automatic step is a step that involves nothing but the execution of a software process. A customized step is primarily automatic, but it requires some input along the way from the user of the guided procedure. An example of a customized step would be when the system needs to access a particular web site, but the user has to supply a username and password to access the web site.

At 120, the author enters the properties of the steps being added such as the step title and the step type (manual, automatic, custom). The author can also create a help section for this step at 130 by providing information about the step such as what needs to be done to carry out the step and what will happen as a result of the step being carried out. The activities section 140 allows the author to add the activities that are required to carry out the step. Once again, the author can list whether each step is manual, automatic, or custom in nature. The author can also indicate a link to a process for an automatic step and/or documentation for each activity. The help section 150 is used by the author to provide detailed information about each activity. In an embodiment, an author can select steps from a standard library or list of available steps (and the steps associated activities), thereby permitting the reuse of steps and making easier the authoring of new guided procedures.

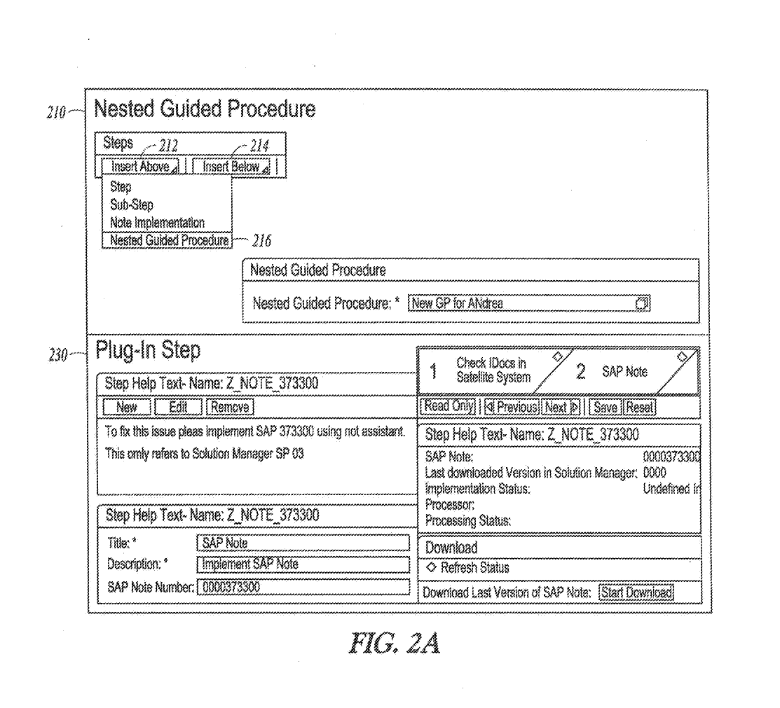

FIGS. 2A and 2B are another example of a user interface used in connection with authoring and creating a guided procedure. The author of the guided procedure can at 210 nest existing guided procedures within the guided procedure that the author is creating. As indicated at 212, 214, and 216, the nested guided procedure can be inserted above or below a certain step in the guided procedure that is being authored. At 220, the author of the guided procedure can make a hierarchy of steps in the guided procedure by making a step a parent of another step. Such a hierarchy will allow a user of the guided procedure to more easily understand the execution of the steps and activities of the guided procedure. At 230, the author of the guided procedure can use a plug in, and at 240, the author indicates that he or she is finished with the step creation process.

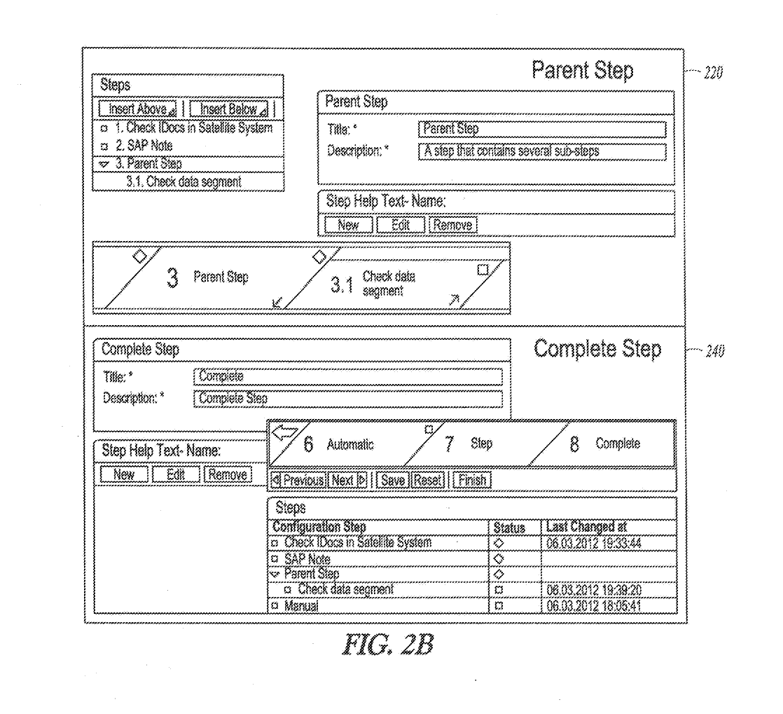

FIG. 3 is a block diagram of a high level architecture 300 of a guided procedure authoring tool 310, a guided procedure framework 330, and a software infrastructure 350. The architecture 300 includes an application manager 320, and the managerial applications include such processes as manager set up 322, guided self services 324, data volume management 326, exception management 328, and technical operations 329. These processes are basically consumers of the framework, and each one is specialized in a particular technical topic as implied by their nomenclature. Additionally, each is linked to the framework and allows for the creation and execution of guided procedures. In an embodiment, the software tool 310 to implement the authoring of guided procedures can be made a part of the application manager 320. The content 333 for the guided procedures (that is, guided procedures, steps, and activities) is provided by the software provider as dynamic content 331 or self-service content 332. Dynamic content 331 is dynamic in nature in that the content can change based on the situation. Self-service content 332 can be used by a user without any additional assistance. In some embodiments, a software developer and provider can deliver a guided procedure at any time. These guided procedures can originate from either dynamic content or self service content. In this way, a customer can download standard guided procedures for different topics, modify them, and execute. The self services and dynamic content are mainly repositories of guided procedures that are available for downloading. Self service guided procedures can replace existing self services delivered by a software provider. These guided procedure allow the customer to perform standard measurements in the system, to identify vulnerabilities, or to optimize processes. The finality of a guided procedure of this type refers to the feature wherein it can generate a report that the user can send to the software provider for assistance. Dynamic content is also the storage of the guided procedures created by the software provider for topics other than self services. As noted at 334, 335, and 336, the steps of the guided procedure content 333 can include manual steps 334, customized steps 335, and automatic steps 336.

The tool bar 360 permits a customer or user of the software applications to author a guided procedure, so that the guided procedures available on a system include guided procedures 331, 332 that originate from the software provider, and those that are authored and created by a customer or user of the system. For a user to author a guided procedure, the user specifies a solution at 361, which means that an author identifies an issue to which the guided procedure will relate. At 362, the author specifies the users for whom the guided procedure will be available, and the manner with which these users will be connected to the guided procedure. At 363, the author specifies the landscape of the framework and infrastructure which the guided procedure will occupy. At 364 and 365, the author can specify particular steps of the guided procedure as either manual or automatic. In other example embodiments, the author may also specify certain steps as being customized. At 366, the author indicates that he or she has completed the creation of the guided procedure. FIG. 3 further illustrates the infrastructure 350 of the system, and includes generic storage 351, secure storage 352, user interface components 353, web services 354, and diagnostic agents 355.

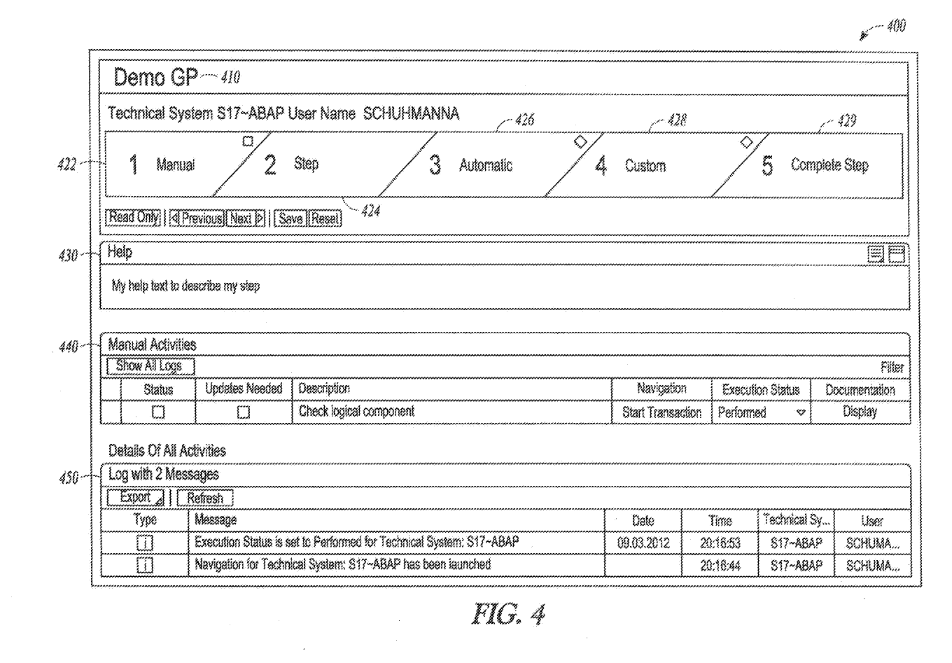

FIG. 5 is another block diagram of a high level architecture 500 of a guided procedure authoring tool, a guided procedure framework, and a software infrastructure. The architecture 500 includes manager applications 510 that include setup 512, guided self service 514, and data volume management (DVM) analysis 516. On the client side 520, the guided procedures can be used in connection with at least exception management 522, technical administration 524, and cross database comparisons 526. The guided procedure framework 530 includes the guided procedure browser/guided procedure maintenance modules 532. The modules 532 are used at execution time at 534 by a user to execute the guided procedure. The content 540 of the guided procedures includes a guided procedure content file 542, which consists of provider content 544 and customer content 546. A guided procedure directory 548 includes statuses and logs. The guided procedure content 540 is imported into the guided procedure framework 530 via import/export module 534. A guided procedure import/export module 536 moves content between the guided procedure framework 530 and the guided procedure content 540.

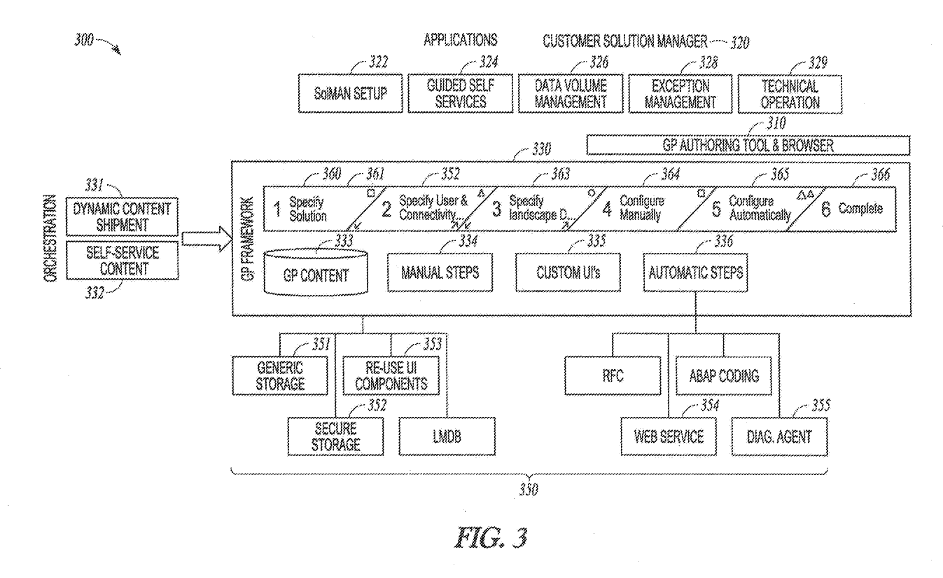

FIG. 4 is an example user interface 400 for use in connection with executing a guided procedure. The name of the guided procedure is indicated at 410. The tool bar indicates a roadmap of the guided procedure 410, that is, the manual steps 422, steps 424, automatic steps 426, custom steps 428, and completion of the steps at 429. Help section 430 provides detailed information for each step, activities section 440 lists the activities for each step, and log 450 records the results or issues that are associated with the execution of each step and activity.

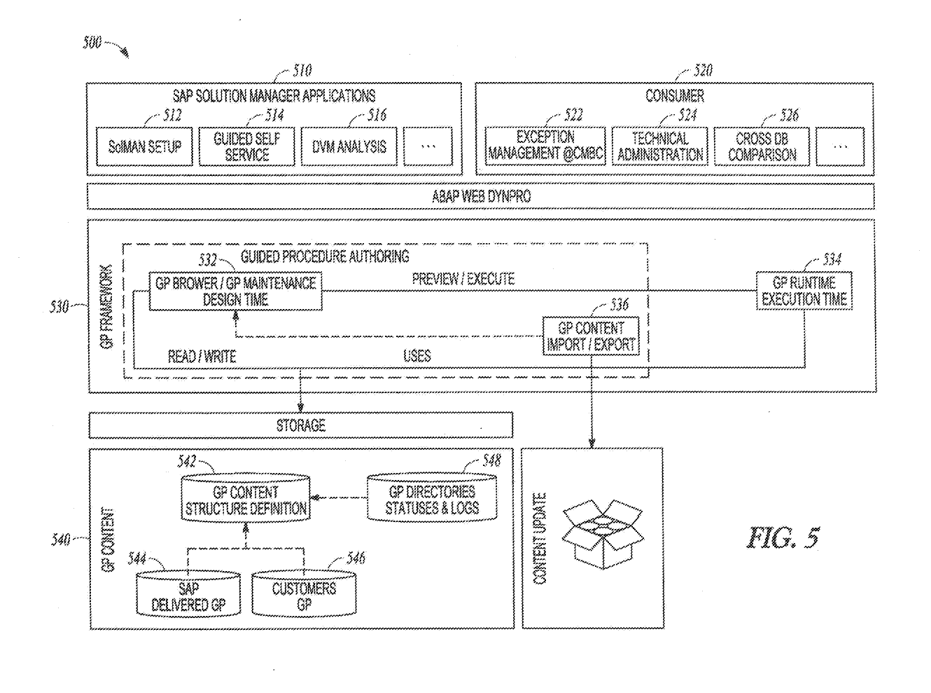

FIG. 6 is a flow chart of an example embodiment of a process 600 to execute an authoring of guided procedures. FIG. 6 includes a number of process blocks 610-620. Though arranged serially in the example of FIG. 6, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 6, at 610, guided procedures are maintained in an infrastructure. The guided procedures include step by step instructions relating to assisting a user of the infrastructure. At 620, a software tool is provided via a user interface. The software tool relates to the plurality of guided procedures, and is configured to permit a user to create a guided procedure, to activate the guided procedure, and to publish the availability of the guided procedure.

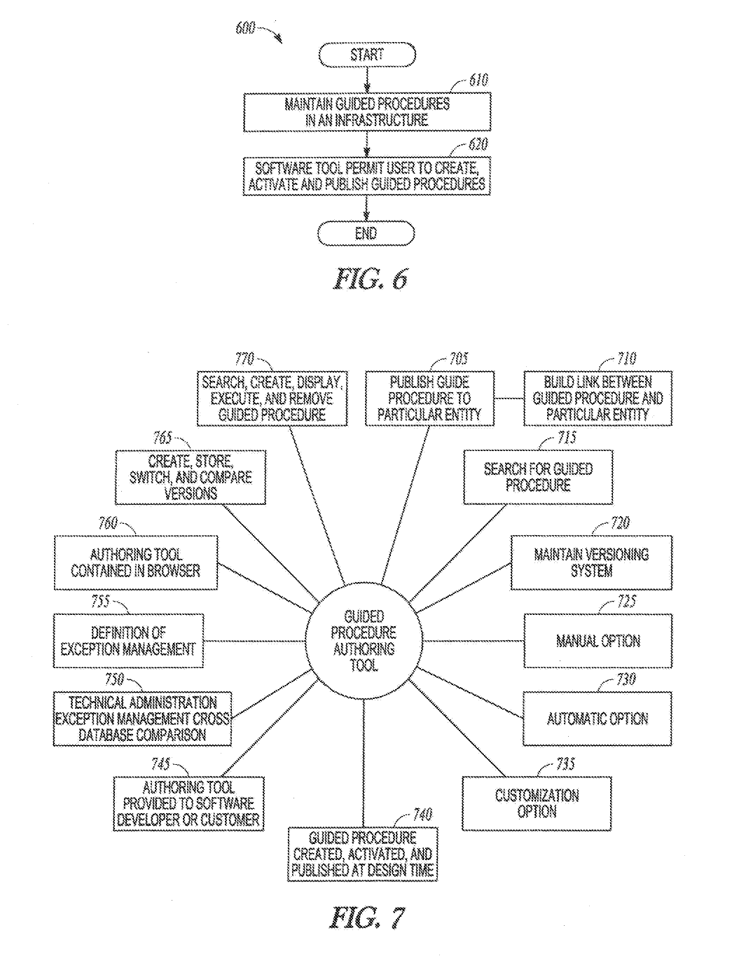

FIG. 7 is a block diagram illustrating features of a software tool for creating or authoring a guided procedure.

At 705, the software tool is configured to publish the availability of a particular guided procedure to particular entities, such that only the particular entities are permitted to access the particular guided procedure. At 710, the publication of the availability of the particular guided procedure includes building a link between the particular guided procedure and the particular entities.

At 715, the software tool is configured to assign attributes to the procedures, receive search criteria from the user, compare the search criteria and the attributes, and report to the user relevant procedures as a function of the attributes and search criteria. This feature permits a user to search for guided procedures that may assist the user in a particular issue that that the user is dealing with on the system. At 720, the software tool is configured to maintain a versioning system for the guided procedures. This feature permits a particular version of a guided procedure to be associated with a particular sub-system, a particular group or entity, or a particular issue on the system or sub-system.

At 725, the software tool is configured to provide a manual option. The manual option relates to a step in a guided procedure that requires some manual or physical action by the user of the guided procedure. For example, as noted above, there may be a problem with a disk or a disk drive, and such disk or disk drive would have to be physically replaced. At 730, the software tool is configured to provide an automatic option that automatically executes the steps in a guided procedure. This feature is most typically taken care of by the software provider or a technology provided by the software provider, and can be implemented via the use of software processes, such as invoking an application program interface (API) for use in the infrastructure. At 735, the software tool is configured to provide a customization option. The customization option relates to a step in a guided procedure that the software provider could do or could provide a process to do, but the software provider still needs some information from the customer. For example, the software provider could have code in a guided procedure to access a web site, but the software provider still may need a user name and password from the user.

At 740, the software tool is used at the design time of a system to create the guided procedure, to activate the guided procedure, and to publish the guided procedure. At 745, the system is configured such that the software tool is made available to a business entity, software developer, or software company that created the system and infrastructure. The software tool can also be made available to a customer that uses the system and infrastructure. In this manner, while it is most typical that the software company provides the guided procedures, the customer can also author guided procedures using the software tool. At 750, the software tool is configured such that the business entity or customer can create procedures for technical administration, exception management, and cross database comparison. At 755, the exception management is handled by the software tool, and the exception management includes defining the scope of systems and scenarios handled by the exception management, defining the configuration of extractors for the exception management, defining a schedule for the selected extractors, and reviewing the steps of the execution management setup.

At 760, the software tool is part of a browser, and the browser-based software tool includes predefined reusable graphical user interface elements including at least one of standard steps and sub-steps for use in the guided procedures, a plug-in step for use in the guided procedures, nested guided procedures for use in the guided procedures, and a completion step for use in the guided procedures. At 765, the software tool is configured to create a new version of a guided procedure, store different versions of the guided procedure, switch among versions of the guided procedure, and compare versions of the guided procedure; wherein versions of the guided procedure comprise different steps and activities. At 770, the software tool is configured to permit a user to search for the guided procedures, display the guided procedures, create the guided procedures, execute the guided procedures, and remove the guided procedures.

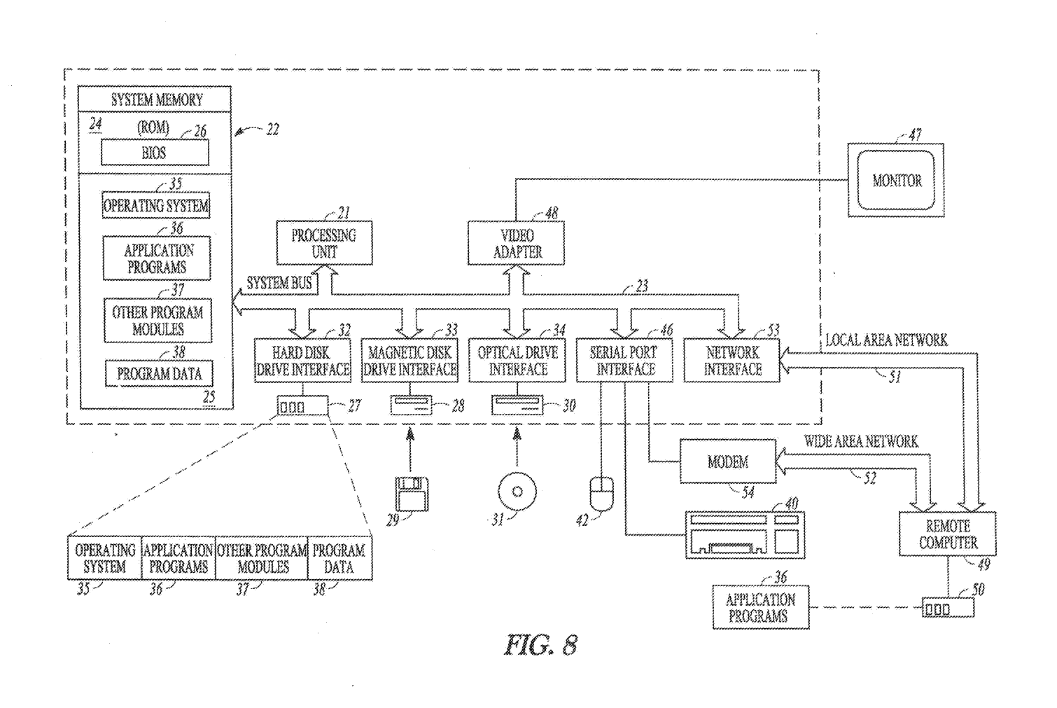

FIG. 8 is an overview diagram of a hardware and operating environment in conjunction with which embodiments of the invention may be practiced. The description of FIG. 8 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 8, a hardware and operating environment is provided that is applicable to any of the servers and/or remote clients shown in the other Figures.

As shown in FIG. 8, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMS), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 8 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor and a computer storage device configured to:
maintain a plurality of procedures in an infrastructure, wherein the procedures comprise step by step instructions relating to assisting a user of the infrastructure; and
provide a software tool via a user interface relating to the plurality of procedures;
wherein the software tool is configured to permit a user to create a procedure, to activate the procedure, and to publish the availability of the procedure.

2. The system of claim 1, wherein the software tool is configured to publish the availability of a particular procedure to particular entities, such that only the particular entities are permitted to access the particular procedure.

3. The system of claim 2, wherein the publication of the availability of the particular procedure comprises building a link between the particular procedure and the particular entities.

4. The system of claim 1, wherein the software tool is configured to assign attributes to the procedures, receive search criteria from the user, compare the search criteria and the attributes, and report to the user relevant procedures as a function of the attributes and search criteria.

5. The system of claim 1, wherein the software tool is configured to maintain a versioning system for the procedures, such that a particular version of a procedure can be associated with a particular sub-system, a particular group or entity, or a particular issue on the system or sub-system.

6. The system of claim 1, wherein the software tool is configured to provide a manual option.

7. The system of claim 1, wherein the software tool is configured to provide an automatic option that automatically executes the steps in a procedure.

8. The system of claim 1, wherein the software tool is configured to provide a customization option.

9. The system of claim 1, wherein the use of the software tool in the creation of the procedure, the activation of the procedure, and the publication of the procedure occurs at a design time of the system.

10. The system of claim 1, wherein the system is configured such that the software tool is made available to at least one of a business entity that created the system and infrastructure, and a customer that uses the system and infrastructure.

11. The system of claim 10, wherein the software tool is configured such that the business entity or customer can create procedures for technical administration, exception management, and cross database comparison.

12. The system of claim 11, wherein the exception management is handled by the software tool, and the exception management comprises defining the scope of systems and scenarios handled by the exception management, defining the configuration of extractors for the exception management, defining a schedule for the selected extractors, and reviewing the steps of the execution management setup.

13. The system of claim 1, wherein the software tool is part of a browser, and the browser-based software tool comprises predefined reusable graphical user interface elements including at least one of standard steps and sub-steps for use in the procedures, a plug-in step for use in the procedures, nested guided procedures for use in the procedures, and a completion step for use in the procedures.

14. The system of claim 1, wherein the software tool is configured to create a new version of a procedure, store different versions of the procedure, switch among versions of the procedure, and compare versions of the procedure; wherein versions of the procedure comprise different steps and activities.

15. The system of claim 1, wherein the software tool is configured to permit a user to search for the procedures, display the procedures, create the procedures, execute the procedures, and remove the procedures.

16. A process comprising:
maintaining a plurality of procedures in an infrastructure, wherein the procedures comprise step by step instructions relating to assisting a user of the infrastructure; and
providing a software tool via a user interface relating to the plurality of procedures;
wherein the software tool is configured to permit a user to create a procedure, to activate the procedure, and to publish the availability of the procedure.

17. The process of claim 16, comprising publishing the availability of a particular procedure to particular entities, such that only the particular entities are permitted to access the particular procedure.

18. The process of claim 16, comprising assigning attributes to the procedures, receiving search criteria from the user, comparing the search criteria and the attributes, and reporting to the user relevant procedures as a function of the attributes and search criteria.

19. The process of claim 16, comprising maintaining a versioning system for the procedures, such that a particular version of a procedure can be associated with a particular sub-system, a particular group or entity, or a particular issue on the system or sub-system.

20. The process of claim 16, comprising providing a manual option, an automatic option, and a customization option for the steps in the procedure.

21. The process of claim 16, comprising creating a new version of a procedure, storing different versions of the procedure, switching among versions of the procedure, and comparing versions of the procedure; wherein versions of the procedure comprise different steps and activities.

22. The process of claim 16, comprising searching for the procedures, displaying the procedures, creating the procedures, executing the procedures, and removing the procedures.

23. A computer readable storage device comprising instructions that when executed by a processor executes a process comprising:
maintaining a plurality of procedures in an infrastructure, wherein the procedures comprise step by step instructions relating to assisting a user of the infrastructure; and
providing a software tool via a user interface relating to the plurality of procedures;
wherein the software tool is configured to permit a user to create a procedure, to activate the procedure, and to publish the availability of the procedure.

24. The computer readable storage device of claim 23, comprising instructions for publishing the availability of a particular procedure to particular entities, such that only the particular entities are permitted to access the particular procedure.

25. The computer readable storage device of claim 23, comprising instructions for assigning attributes to the procedures, receiving search criteria from the user, comparing the search criteria and the attributes, and reporting to the user relevant procedures as a function of the attributes and search criteria.

26. The computer readable storage device of claim 23, comprising instructions for maintaining a versioning system for the procedures, such that a particular version of a procedure can be associated with a particular sub-system, a particular group or entity, or a particular issue on the system or sub-system.

27. The computer readable storage device of claim 23, comprising instructions for providing a manual option, an automatic option, and a customization option for the steps in the procedure.

28. The computer readable storage device of claim 23, comprising instructions for creating a new version of a procedure, storing different versions of the procedure, switching among versions of the procedure, and comparing versions of the procedure; wherein versions of the procedure comprise different steps and activities.

29. The computer readable storage device of claim 23, comprising instructions for searching for the procedures, displaying the procedures, creating the procedures, executing the procedures, and removing the procedures.
